(19) United States
(12) Patent Application Publication
(10) Pub. No.: US 2007/0080513 A1
(43) Pub. Date: Apr. 12, 2007

(54) Device for modifying the wheel camber of a wheel on a motor vehicle

(76) Inventors: Jurgen Osterlanger, Emskirchen (DE); Manfred Kraus, Herzogenaurach (DE); Ulrich Grau, Emskirchen (DE); Ivo Agner, Buhl (DE); Oswald Friedmann, Lichtenau (DE); Dirk Eifler, Kaltenhouse (DE); Wolfgang Hill, Karlsruhe (DE); Manuel Metzinger, Buhl (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/574,379

(22) PCT Filed: Aug. 25, 2004
(86) PCT No.: PCT/EP04/09479

§ 371 Date: Apr. 3, 2006

(30) Foreign Application Priority Data
Oct. 15, 2003 (DE) 10348682.8

(51) Int. Cl. B62D 17/00

(52) U.S. Cl. 280/86.751

(57) ABSTRACT

A device for modifying the wheel camber of a wheel (1) on a motor vehicle is provided, in which the heel (1) is pivotally mounted to a wheel carrier (5, 51) by a pivot bearing (4, 50). A pivoting plane is defined by the pivot bearing (4, 50) which extends in an approximately transverse manner to a central plane (E) of the wheel, the position of a virtual center of rotation (D) of the pivot bearing (4, 50) lying above the wheel contact plane and on a side of the central plane (E) of the wheel that faces toward the vehicle.

### BACKGROUND

The invention relates to a device for modifying the wheel camber of a wheel on a motor vehicle. Such active camber adjusters modify the wheel camber depending on the appropriate driving situation, for example, when driving around curves, when braking, or when accelerating.

For example, from DE 102 49 159 A1, a guide device for a wheel, especially on a motor vehicle, has become known, with a circular arc guide, whose axis lies in the region of the intersection line between the driving surface and the center plane of the wheel, wherein the circular arc guide runs in the region of the wheel bearing. This guide device can be used in numerous existing wheel suspensions. For a relative displacement of the wheel relative to the circular arc guide, the wheel camber is manipulated. Practical embodiments do not follow from DE 102 49 159 A1. Furthermore, according to this disclosure, the rotational point of the pivot bearing is located approximately underneath the wheel contact plane, thus approximately underneath the driving surface. Indeed, the effective lever arm is kept small, wherein the lever arm is formed by the distance between the force application point of the wheel forces and the rotational point of the pivot bearing. If the rotational point of the pivot bearing lies, as here, under the street, the vehicle body moves somewhat to the left relative to the wheels when driving along a curve to the right, if the outer wheel in the curve is adjusted to a negative camber and the inner wheel in the curve is adjusted to a positive camber. This can represent a car body reaction that is incomprehensible for the driver.

### SUMMARY

The objective of the present invention is to create a device according to the features of the preamble of claim 1, in which this disadvantage is eliminated.

According to the invention, this objective is met in that the position of a virtual rotational point of the pivot bearing is above the wheel contact plane and on the side of the center plane of the wheel facing the vehicle, thus axially inside of the center plane of the wheel. The smaller the distance above the street, the smaller the torque that is required to be introduced by the actuator. The undesired car body reaction described above fails to appear. A preferred field, which is to contain the rotational point of the pivot bearing, is found in order to enable optimal activation of the pivot bearing. First, as a zero point or reference point, an intersection point is formed by a Y-axis intersecting the rotational axis of the wheel and lying in the center plane of the wheel and an X-axis lying in the wheel contact plane, wherein the X-value should be smaller than 150 mm and the Y-value should be smaller than 150 mm.

Within this field, a radius vector can be given, on which the rotational point of the pivot bearing is to lie with reference to a properly proportioned loading of the actuator. This radius vector intersects the intersection point of the X-axis lying in the wheel contact plane with the already defined Y-axis, wherein the radius vector covers an angular region, whose lower value relative to the X-axis equals approximately 30° and whose upper value equals approximately 60°. Within this angular region, X-values and Y-values can also be set, which are greater than 150 mm, in order to achieve properly proportioned loading of the actuator.

For a 17″ wheel, for example, good positioning of the rotational point is given with the following values: starting with the intersection point named above as the zero point, suitable value pairs are X=35 mm and Y=30 mm, X=50 mm and Y=50 mm, and X=103 mm and Y=140 mm. With this positioning of the rotational point, the work to be performed by the actuator is properly proportioned for the various driving situations. In any case, the rotational point should lie on the inside of the wheel, thus facing towards the vehicle. Then the virtual lever is in the wheel contact plane and the rotational point of the pivot bearing has a properly proportioned ratio both for curves to the left and also to the right.

Preferably, the pivot bearing has a fixed pivot bearing part, which is fixed relative to the wheel carrier, and a pivoting pivot bearing part arranged so that it can pivot in the pivot plane relative to the fixed pivot bearing part. In this case, the wheel can be supported on the pivoting pivot bearing part so that it can rotate, for example, by means of a conventional wheel bearing.

In this arrangement, it is especially advantageous when an electromechanical actuator is used, which, on one side, is supported opposite the wheel carrier and, on the other side, engages the pivoting pivot bearing part. Such electromechanical actuators have an electric motor powered by the electric on-board power supply of the motor vehicle. Because the position of the virtual rotational point is properly proportioned according to the invention for all driving situations, conventional electric motors can be used, which can be operated without any trouble with the electric energy provided by the on-board power supply.

For the use of the electromechanical actuator in the previously described arrangement, positions of the virtual rotational point are also conceivable, which lie outside of the indicated defined region.

Preferably, the electromechanical actuator includes an electric motor and a roller body screw drive, whose spindle nut is supported on a threaded spindle so that it can rotate. Such known electromechanical actuators reliably convert a rotational motion into a translational motion. The translational motion is used as an adjustment motion for adjusting the pivoting pivot bearing part.

Preferably, the spindle nut is embodied as a rotor of the electric motor, wherein the threaded spindle is then locked in rotation. This has the advantage that the threaded spindle can be held, for example, directly on the pivoting pivot bearing part.

The electric motor heats up under loading. This heat must be dissipated, so that the engine does not overheat, especially at low driving speeds after prior extreme loading. Cooling by air alone is possibly inadequate. To further cool the electric motor, it is mounted directly on the wheel carrier according to an improvement of the invention. The connection is provided in that a contact with very good heat transfer from the electric motor to the wheel carrier usually formed from metal is guaranteed. Consequently, the heat is discharged into the wheel carrier. The point of introduction is preferably one that is cooler than the motor. A suitable position can be, for example on the wheel carrier above the transverse suspension arm. Due to the relatively large mass of the wheel carrier in comparison to the size of the electric motor, its heat storage capacity can be taken advantage of. This position is also protected from impacts from stones and undesired contact with the ground by the vehicle.

It was already mentioned that the threaded spindle can preferably be locked in rotation with the pivoting pivot bearing part. Furthermore, in an improvement according to the invention, the threaded spindle is held on this pivoting pivot bearing part so that it cannot move in the axial direction, wherein the pivoting part makes rocking movements relative to the threaded spindle about a rocking axis transverse to the threaded spindle. When the electric motor is activated, in this selected example arrangement, the threaded spindle is displaced along its axis. If the axis of the threaded spindle is designated as one leg and the connection line between the virtual rotational point and the connection point to the threaded spindle on the pivoting pivot bearing part is designated as a second leg, the connection point represents the intersection point of the two legs, for example, at a camber adjustment of 0°, an output angle between these two legs is set. By activating the actuator, this angle changes. The previously described rocking arrangement in the attachment point consequently prevents undesired transverse forces or bending torques from being introduced into the threaded spindle.

In order to enable, on one hand, a play-free attachment of the pivoting pivot bearing part and, on the other hand, problem-free rocking motion, it is proposed to support a peg, which is arranged transverse to the threaded spindle, in the radial direction on the threaded spindle by means of an especially biased roller bearing, especially a needle roller bearing, wherein the peg can be mounted on the pivoting pivot bearing part. This play-free connection between the pivoting pivot bearing part and the threaded spindle is used for trouble-free, precise attachment conditions. Alternatively, it is also possible to lock the peg in rotation on the threaded spindle and to support the peg in the radial direction by means of radial roller bearings on the pivoting pivot bearing part.

The present invention is also suitable for driven wheels. To guarantee the movement freedom of the wheels, optionally the wheel gauge can be increased somewhat in order not to impact the wheel housings and spring arms; then, optional changes to the wheel housings and spring arms do not have to be performed. Furthermore, the bending angle of the steering drive shaft is critical during spring deflection and rebound and during steering of the wheel. The main influencing parameter, in addition to the steering angle and spring paths, is primarily the length of the drive shaft between the joints. When the wheel is adjusted to a negative camber, the bending angle may not be increased too much. This results in the requirement that the axial installation length of the pivot bearing according to the invention may not become too large. However, in order to support the bending torques resulting from the lateral guide forces on the wheel on the pivot bearing, for strength reasons, a certain camber length is necessary, which defines the necessary installation space in the axial direction. All of these criteria are taken into account, such that an improvement according to the invention provides the lead through of the drive shaft through the wheel bearing. The drive shaft does not have to be unduly shortened and the bending angle does not have to be increased. Preferably the pivot bearing, the wheel bearing, and the drive shaft are arranged one inside the other. In comparison with known arrangements without the pivot bearing according to the invention, there results only an insignificant or even no shortening at all of the drive shaft in the extreme case of the greatest adjustable negative camber, because in this position, the necessary wheel gauge increase nearly balances out the theoretical shortening of the drive shaft when adjusted into this position.

The provision of the pivot bearing according to the invention possibly requires additional spatial requirements. In addition, trouble-free lubrication of the pivot bearing must be ensured. An improvement according to the invention provides that the pivot bearing, the wheel bearing, and the joint of the drive shaft are arranged in a common lubricating space provided with lubricant. Consequently, only one lubricating space is necessary, so that additional installation space is minimized. The pivot bearing, the wheel bearing, and the cardan shaft can be lubricated with a suitable heavy-duty grease. The lubricating space is preferably defined by a common seal, especially by a folding or rolling bellows, which contacts, on one side, the fixed pivot bearing part and, on the other side, the cardan shaft. While this seal can be arranged on the side of the fixed pivot bearing part in a fixed and sealed way, an improvement according to the invention provides that a seal packing supported on the cardan shaft so that it can rotate is arranged between the seal and the cardan shaft. This seal packing can be provided, for example, with seal lips.

On the outside of the wheel, a seal for the pivot bearing is similarly to be provided. The wheel bearing can be sealed itself by means of a sheet gasket. The pivot bearing can be sealed by means of a rolling bellows. In comparison with a folding bellows seal, this rolling bellows has the advantage that it can have a very small radial dimension due to the large bending radii of elastomer with small wall thickness and also can be very short in the axial direction. The bending bead moves only about half the amount for a certain stroke of the pivot bearing. This sealing system enables a solid seal, wherein a sliding sealing lip can be eliminated. With this seal, which is small in the axial and radial directions, the tight space within a brake disk can be used optimally. A collar, either as an additional part or also formed integrally on the pivoting pivot bearing part, can be attached to the pivoting pivot bearing part on the outer side of the wheel. With its closed surrounding surface, this collar simultaneously enables the holding of the rolling bellows seal and provides for a uniform introduction of the actuator forces and the braking torque into the pivoting pivot bearing part.

The threaded spindle of the actuator can be housed in a seal, which can also be embodied as a folding or rolling bellows. In this way, the threaded spindle is protected from undesired contamination in a trouble-free way.

So that a trouble-free pivoting motion between the fixed pivot bearing part and the pivoting pivot bearing part can be realized even under large loads, in an improvement according to the invention, a roller bearing is provided between the fixed pivot bearing part and the pivoting pivot bearing part, in which roller bodies roll on arc-shaped tracks. The diameter of the roller body is adapted to the pivot angle to be realized, wherein the goal can be, for example, for a camber adjustment by 3°, to turn the loaded roller body at least once over its complete roller extent. In this way, undesired plastic deformation and premature damage can be avoided and uniform loading of the tracks can be ensured.

Preferably, for such a roller bearing, at least one endless roller body channel is provided, in which the roller bodies can circulate endlessly, wherein the roller body channel has a load section with the arc-shaped tracks, a return section, and two deflection sections connecting the load section to the return section to form an endless path. In contrast to a finite roller body chain, which performs only a back and forth motion, here it can be ensured that each roller body of the roller body chain can pass each position of the tracks during operation, thus it can also perform, if necessary, a complete circulation in the roller body channel.

Preferably, the pivoting pivot bearing part and the fixed pivot bearing part are arranged one inside the other and provided with the arc-shaped tracks on facing outer surfaces. In addition, one of the two pivot bearing parts is provided with the return sections. These return channels can be embodied, for example, as straight bore holes. The deflection sections are preferably provided on head pieces, which can be flange mounted, for example, on ends of the pivot bearing facing away from each other.

The outer fixed or pivoting pivot bearing part can be provided as a hollow profile and can be assembled from two longitudinal parts, wherein the longitudinal axis of this pivot bearing part lies in the plane separating the two longitudinal parts.

Dividing this pivot bearing part into two longitudinal parts has the advantage that on the appropriate inner side of each longitudinal part, the tracks for the roller bearing can be produced without trouble, for example, in one grinding process. If these two parts are then joined together again, proper positioning is necessary. This can be simplified if this pivot bearing part embodied as a hollow profile is first embodied as a single component, wherein desired fracture points are provided along the separating plane. This component can now be broken apart along the desired fracture points, so that the two longitudinal parts are formed, wherein the two longitudinal parts are provided at their fracture points lying in the separating plane and facing each other with fracture surfaces, which enable a precisely fitting joining of the two longitudinal parts.

The pivoting or fixed pivot bearing part, in this case on the inside, can be provided with a tubular shape viewed in cross section and can be provided on its outer surface with several ridges distributed over the periphery and arranged concentric to the rotational point of the pivot bearing, wherein the ridges carry the tracks. Preferably, these ridges are provided with the tracks for the roller bodies on opposing peripheral sides.

In order to lock the set camber position of the wheel in the case of loss of power or when parked, an improvement according to the invention provides a fail-safe device, with which a camber position of the wheel can be detachably locked. If, for example, an electromechanical actuator is provided, in which a threaded spindle and the spindle nut arranged so that it can rotate on the threaded spindle are provided, the fail-safe device preferably has a positive-fit part for a positive-fit connection of the spindle nut with a part fixed to the frame.

For example, the nut of the spindle drive can be mechanically blocked reliably by means of a pin and a spring. If sufficient power-supply voltage is provided, the pin can be pulled, for example, magnetically, from its locked position, wherein then a rotational motion of the nut is enabled by the electric motor and thus active camber adjustment. This magnet can be mounted, for example, on the wheel carrier. Through end teeth provided with a defined angle, in which a pin engages with an angled tip, it is possible to use the electric motor actively for releasing the locked position. This is especially advantageous when the pin is to be tight due to contamination, and the magnetic force alone is not sufficient. In this case, the magnetic force can be dimensioned so that the pin is guaranteed to be held in the open position. Such a setup enables a space-saving configuration and a reduced electric power consumption, because during the entire control process for the camber, this pin is held in the opened position.

### BRIEF DESCRIPTION OF THE DRAWINGS

The invention is explained in more detail below with reference to two embodiments illustrated in a total of 13 figures. Shown are:

FIG. 1 a cross section through the wheel of a motor vehicle with a device according to the invention;

FIG. 2 a view as in FIG. 1, but with a modified section position;

FIG. 3 in schematic view, a cross section through the wheel of a vehicle with a coordinate system for defining the rotational point of the pivot bearing;

FIG. 4 an electric motor of an electromechanical actuator in a sectioned view;

FIG. 5 a detail from FIG. 2 in an enlarged view;

FIG. 6 a detail from FIG. 1 in an enlarged view;

FIG. 7 a detail from FIG. 1 in an enlarged view;

FIG. 7a a detail from FIG. 1 in an enlarged view;

FIG. 8 a fail-safe device in a schematic view;

FIG. 9 a section through the fail-safe device from FIG. 8 along the line IX-IX;

FIG. 10 a section through the fail-safe device from FIG. 9 along the line X-X;

FIG. 11 a section through the fail-safe device from FIG. 9 along the line XI-XI;

FIG. 12 in schematic view, a cross section through the wheel of a motor vehicle with another device according to the invention; and

FIG. 13 a section along the line XIII-XIII from FIG. 12.

### DETAILED DESCRIPTION OF THE PREFERRED EMBODIMENTS

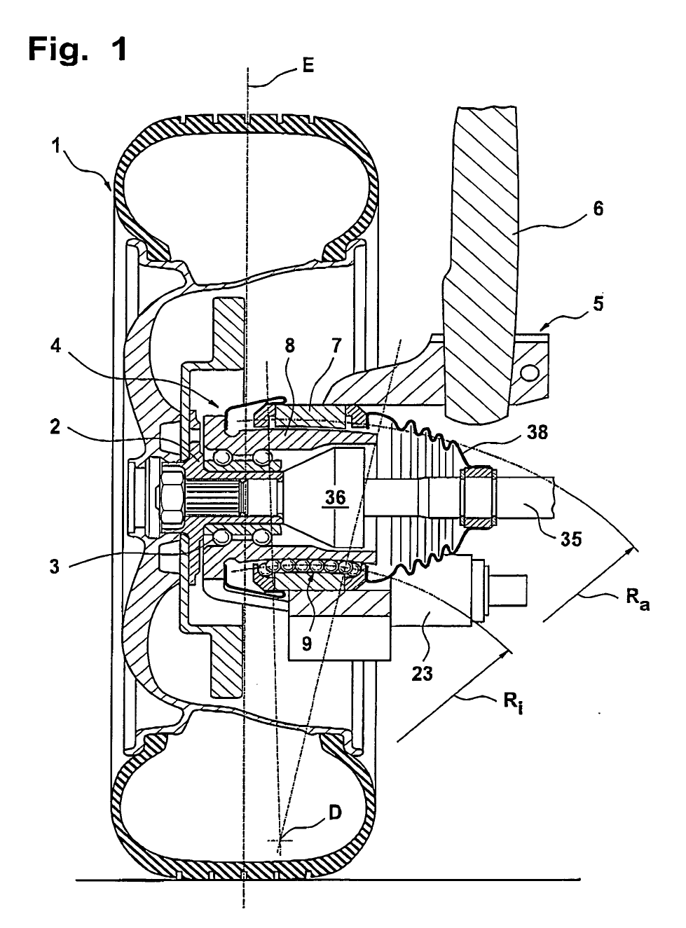

FIG. 1 shows a cross section through the wheel of a motor vehicle with the wheel suspension and a device according to the invention for modifying the wheel camber. The wheel 1 is mounted on its hub 2 so that it can rotate in a wheel bearing 3. The wheel bearing 3 is mounted on a wheel carrier 5 via a pivot bearing 4 so that it can pivot. The pivot bearing 4 has a fixed pivot bearing part 7, which is fixed relative to the wheel carrier 5, and a pivoting pivot bearing part 8, which can pivot relative to the fixed pivot bearing part 7 in the pivot plane E. In the present case, the wheel bearing 3 is mounted on the pivoting pivot bearing part 8.

Pivoting movements of the pivot bearing 4 in the pivot plane have a rotational point D, which, in the present case, is selected to be on the inside of the wheel somewhat above the road surface. This rotational point D is virtual. This virtual rotational point D is due to the configuration of the pivot bearing 4, which is discussed in more detail farther below.

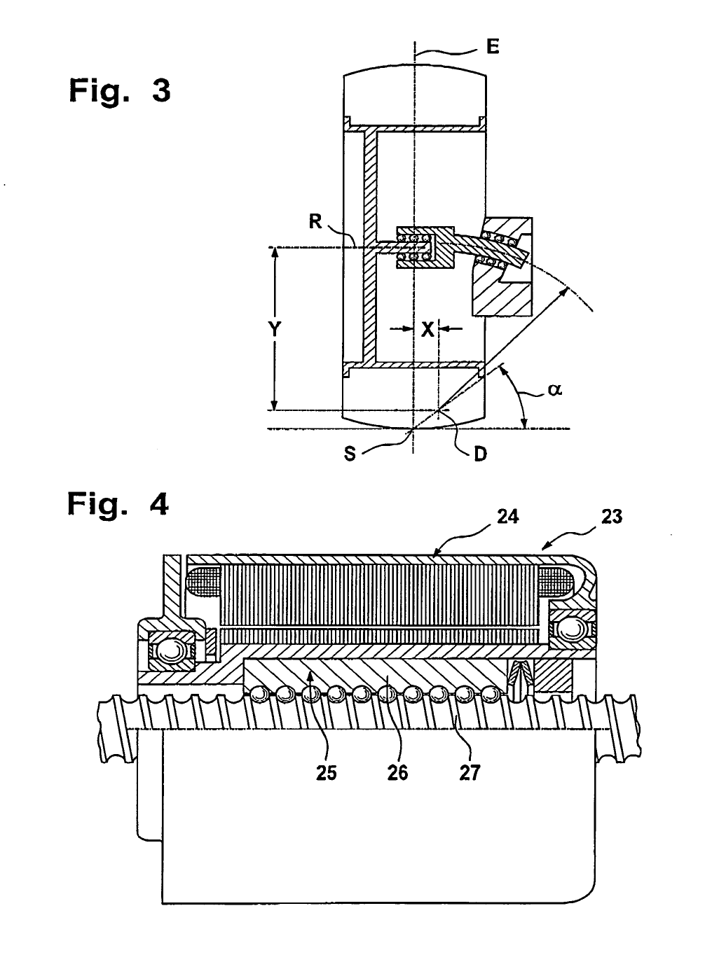

For determining an optimum position of the rotational point D, reference is made to FIG. 3. For the wheel illustrated here, a crowned outer surface is assumed. A y-axis intersecting the rotational axis R of the wheel and lying in the center plane E of the wheel intersects an X-axis lying in the wheel contact plane, so that an intersection point S is formed. The position of the rotational point D of the pivot bearing 4 relative to the intersection point S satisfies the following conditions: X can assume values between 0 mm and 150 mm and Y can assume values between 0 mm and 150 mm. Value pairs of X and Y define the appropriate rotational point D. In this example, for a certain value pair X, Y, a rotational point D of the pivot bearing 4 has been determined. If a straight line is drawn through the intersection point S and the rotational point D, between this straight line and the X-axis lying in the wheel contact plane, an angle α is formed, which—relative to the X-axis—preferably lies between 30° and 60°. The rotational point D lies on this radius vector. If the rotational point D is selected according to these conditions, an optimum lever ratio is set in all driving situations.

FIG. 1 shows in passing that the pivot bearing 4 has a roller bearing 9. This pivot bearing 4 is shown in FIGS. 6 to 7a. What follows from these figures is that the fixed, here outer, pivot bearing part 7 is assembled from two longitudinal parts 10, 11. Both the outer pivot bearing part 7 and also the inner pivot bearing part 8 are both formed as hollow profiles. The longitudinal axis of the outer pivot bearing part 7 lies in the plane dividing the two longitudinal parts 10, 11. The pivoting, here inner, pivot bearing part 8 has an approximately tubular cross section. On the outer periphery of the tubular pivoting pivot bearing part 8 there are several ridges 12, which are distributed over the periphery and which are concentric to the rotational point D of the pivot bearing 4. The ridges 12 have tracks 13 for roller bodies 14, which are here formed by ball bearings, on their opposing peripheral sides.

On its inner periphery, the outer pivot bearing part 7 has several longitudinal grooves 15 distributed over the periphery, wherein peripheral walls of the longitudinal groove 15 have tracks 16 for the roller bodies 14. The tracks 13 and 16 are arc-shaped, so that the tracks 13, 16 have the same rotational axis D of the pivot bearing 4.

It follows from FIG. 7a that the roller bearing 9 is formed as a kind of linear roller bearing with an endless roller body circuit. This roller bearing 9 includes several endless roller body channels 17, of which one is shown schematically in FIG. 7a. In this roller body channel 17, the roller bodies 14 circulate endlessly. This roller body channel 17 has a load section 18 with the arc-shaped tracks 13, 16, also a return section 19, and two deflection sections 20 connecting the load section 18 to the return section 19 in an endless arrangement. With these means and method, an endless roller body circuit is guaranteed. The deflection sections 20 are formed on head pieces 21, which are mounted on the ends of the pivot bearing 4 on the outer pivot bearing part 7. In the present case, the pivot bearing parts 7 and 8 are arranged one inside the other and are provided with the arc-shaped tracks 13, 16 on their facing surfaces.

It follows from FIG. 6 that the dividing surface 22 lying the separation plane is a fracture surface. The longitudinal parts 10, 11, which are initially connected to each other in one piece, are provided on the dividing plane with desired fracture positions not shown here, wherein by applying an explosive force, the outer pivot bearing part 7 is broken apart at the dividing plane. In this way, the two longitudinal parts 10, 11 can be joined together again with a precision fit. Obviously, these longitudinal parts 10, 11 can be produced separately, so that the processing step of breaking the parts apart can be eliminated.

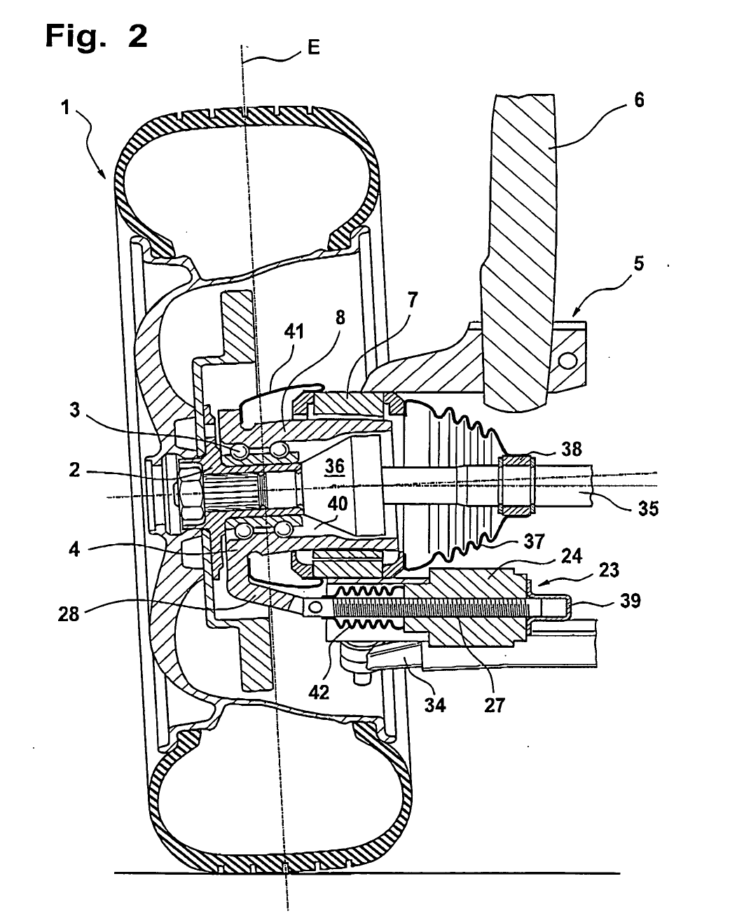

FIG. 1 further shows an electromechanical actuator, which can be seen better in the representation according to FIG. 2. In the present case, this electromechanical actuator 23 includes an electric motor 24, which is mounted on the wheel carrier 5. The connection between the electric motor 24 and the wheel carrier 5 is selected so that a good heat transfer from the electric motor 24 to the wheel carrier 5 is guaranteed. The connection itself is not described here in more detail.

FIG. 4 shows the electromechanical actuator 23 in a partial view. The electric motor 24 here cut longitudinally has a rotor 25, which also forms a spindle nut 26 of a ball screw drive. Ball screw drives have been known for a long time. Usually, a spindle nut is arranged on a threaded spindle (here element 27) so that it can rotate. Between the spindle nut 26 and the threaded spindle 27, ball bearings roll on tracks both of the spindle nut 26 and also of the threaded spindle 27. When the rotor 25 rotates—thus here also the spindle nut—and under the rotationally locked arrangement of the threaded spindle 27, a translational relative displacement takes place between the threaded spindle 27 and the spindle nut 26. In the present case, this translational motion is used for pivoting the pivot bearing part 8.

It follows from FIG. 2 that the threaded spindle 27 engages a lever arm 28, which, in the present case, is formed integrally on the pivoting pivot bearing part 8.

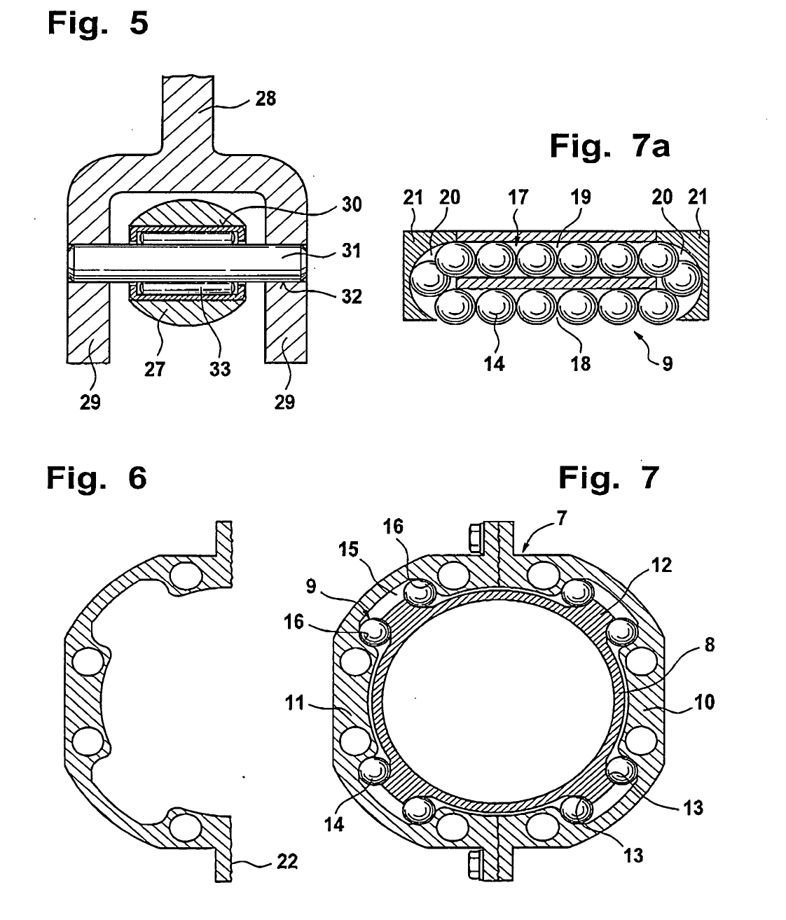

In a greatly enlarged view, FIG. 5 shows the region of the attachment of the pivot bearing 4. It follows from this figure that the lever arm 28 is approximately fork-shaped on its end, such that the threaded spindle 27 engages between the two legs 29. The threaded spindle 27 is provided with a transverse bore hole 30, wherein a peg 31 is guided through this transverse bore hole and inserted rigidly into receiving bore holes of the leg 29. The threaded spindle 27 is arranged on the peg 31 so that it can rock by means of a radial roller bearing 33. In the present case, the radial roller bearing 33 is embodied as a biased needle bearing. In this configuration, it is guaranteed that the attachment is embodied without play.

Furthermore, it follows from FIG. 1 that the electromechanical actuator 23 is arranged somewhat above a transverse suspension arm 34. In this arrangement, the electromechanical actuator 23 is protected, for example, from stone impacts.

The wheels shown in FIGS. 1 and 2 are driven. A drive shaft 35 is arranged coaxial to the pivot bearing 4 and guided through this pivot bearing 4 and through the wheel bearing 3. In this coaxial arrangement, despite the additional pivot bearing 4, a sufficiently low bending angle of the drive shaft 35 is given during operation. FIG. 2 shows a joint 36 of the drive shaft 35, which is protected within the pivoting pivot bearing part 8. The pivot bearing 4, the wheel bearing 3, and the drive shaft 35 with its joint 36 are consequently arranged one inside the other in the radial direction in an axially very space-saving construction.

Furthermore, it follows from FIGS. 1 and 2 that a folding bellows 37 is held with its one end against the fixed pivot bearing part 7 in a lubricant-tight manner. With its opposite end, the folding bellows 37 is arranged above a seal packing 38 supported on the drive shaft 35 so that it can rotate. The folding bellows 37 define a common lubricating space 40 for the pivot bearing 4, the wheel bearing 3, and the joint 36 of the drive shaft 35. While the folding bellows 37 is placed on one side of the fixed pivot bearing part 7, on the side facing away from the vehicle, a rolling bellows 41 for sealing the lubricating space 40 is provided. This rolling bellows 41 is held on one side against the pivoting pivot bearing part 8 in a lubricant-tight manner and on the other side against the fixed pivot bearing part 7.

To protect the threaded spindle 27 of the electromechanical actuator 23 against contamination and damage, a seal cap 42, which is mounted on the electric motor 24, is provided on the end of the threaded spindle 27 facing away from the lever arm 28. Furthermore, another folding bellows 42, which surrounds the threaded spindle 27, is provided on the end of the threaded spindle 27 facing the lever arm 28.

While a neutral camber is shown for the driving situation shown in FIG. 1, FIG. 2 shows the wheel with a positive camber, with a camber angle of approximately 3°.

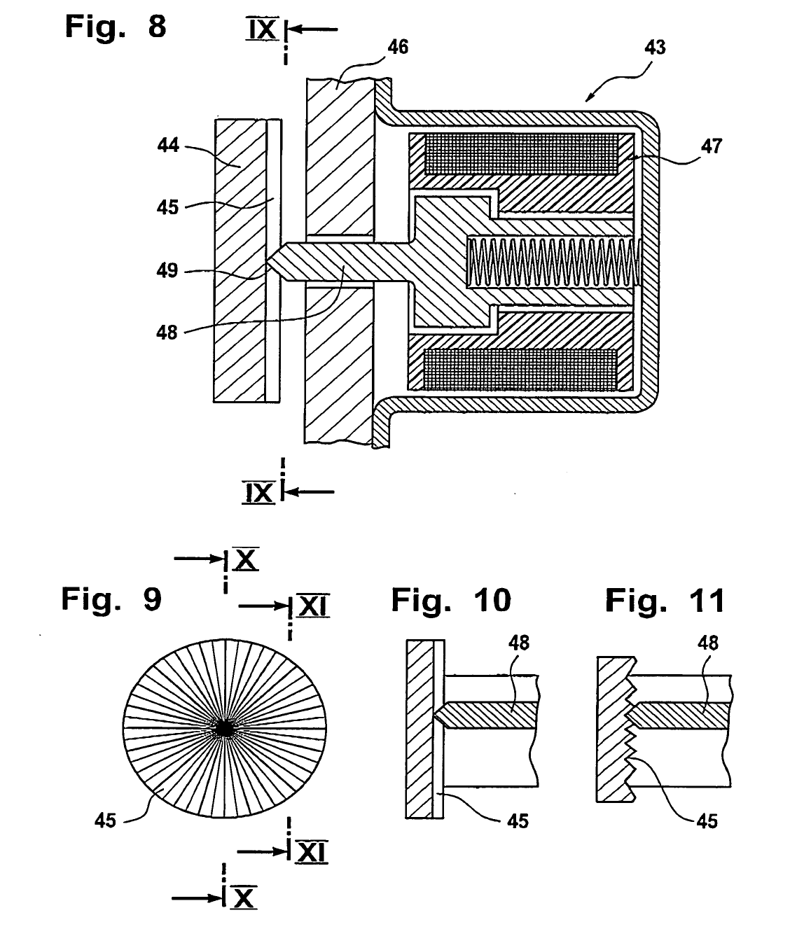

The electromechanical actuator 23 is further provided with a fail-safe device 43 in order to block the rotor 25. This fail-safe device 43 is shown in FIGS. 8 to 11. The rotor 25 locked in rotation with the spindle nut 26 is provided on the end with a locking washer 44, which is provided on one of its ends with end teeth 45. The end teeth 45 can be seen clearly in FIG. 9. An electromagnetic lifting magnet 47 attached to the housing 46 of the electric motor 24 has a locking pin 48, whose free end comes to a point like a wedge. With its wedge-shaped tip, the locking pin 48 can engage with a positive fit into the end teeth 45, as follows, in particular, from FIGS. 10 and 11. The interaction of the wedge-shaped tip 49 with the end teeth 45 guarantees that the locking pin 48 cannot be exposed to such high transverse forces that the detachment of the locking pin 48 would become impossible. If the electromagnetic lifting magnet 47 is actuated for releasing the locking pin 48, and simultaneously the electric motor 24 drives the rotor 25, the rotation of the rotor 25 supports the release of the locking pin 48 due to the wedge effect between the end teeth 45 and the wedge-shaped tip 49. This fail-safe device 43 can be used, for example, in the event of the loss of power or else also when parked.

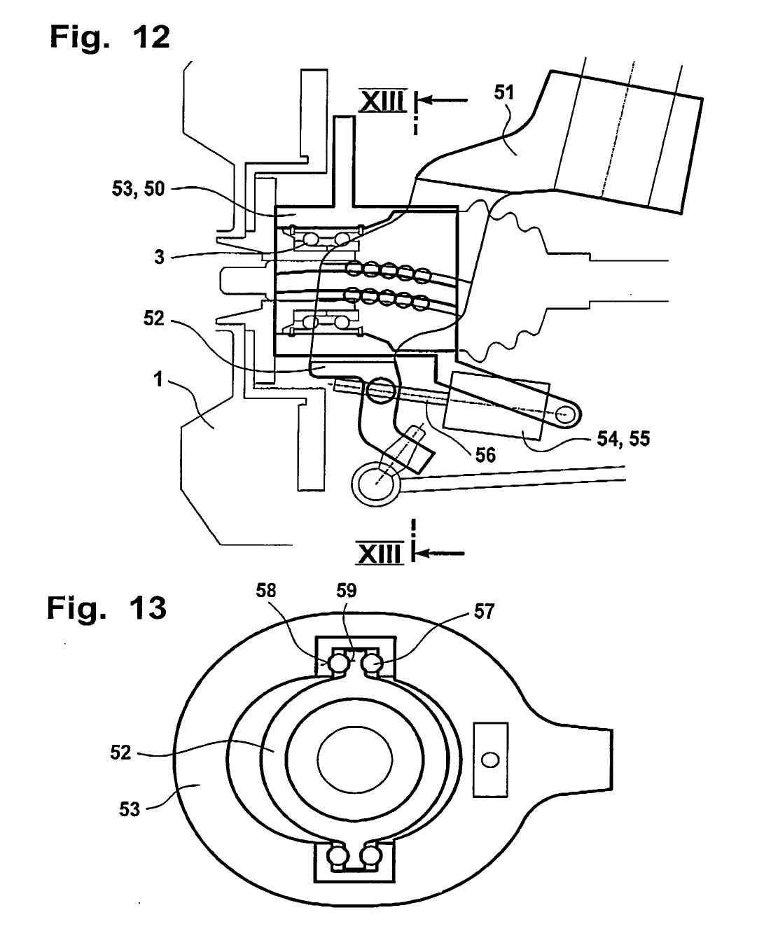

In FIGS. 12 and 13, an alternative configuration of a device according to the invention for modifying the wheel camber of the wheel 1 is shown merely schematically. A pivot bearing 50, which has an outer pivot bearing part 52 mounted on the wheel carrier 51 and a pivot bearing part 53 that can pivot relative to the outer part, is shown with thick lines. The function and action of this modified pivot bearing 50 corresponds to the previously described embodiment. The pivoting pivot bearing part 53 carries the wheel bearing 3.

Here, an electromechanical actuator 54 is also used, which matches the previously described electromechanical actuator. However, the difference with the previously described embodiment is that the electric motor 55 is mounted in an articulated way on the pivoting pivot bearing part 53. The threaded spindle 56 is provided with a spindle nut not shown in more detail, wherein the spindle nut is held on the fixed pivot bearing part 52. When the not-shown rotor of the electric motor 55 rotates, the threaded spindle 56 turns, wherein the pivoting pivot bearing part 53 pivots. The position of the rotational point of the pivot bearing 50 is selected under the same considerations as in the previously described embodiment.

FIG. 13 also shows, as in the previously described embodiment, a roller bearing of the pivoting pivot bearing part 53 relative to the fixed pivot bearing part 52. For this purpose, roller bodies 57 roll on tracks 58, 59 of the two pivot bearing parts 52, 53.

List of Reference Numbers
1 Wheel
2 Hub
3 Wheel bearing
4 Pivot bearing
5 Wheel carrier
6 Spring leg
7 Fixed pivot bearing part
8 Pivoting pivot bearing part
9 Roller bearing
10 Longitudinal part
11 Longitudinal part
12 Ridge
13 Track
14 Roller body
15 Longitudinal groove
16 Track
17 Roller body channel
18 Load section
19 Return section
20 Deflection section
21 Head piece
22 Dividing surface
23 Electromechanical actuator
24 Electric motor
25 Rotor
26 Spindle nut
27 Threaded spindle
28 Lever arm
29 Leg
30 Transverse bore hole
31 Peg
32 Receiving bore hole
33 Radial roller bearing
34 Transverse suspension arm
35 Drive shaft
36 Joint
37 Folding bellows
38 Seal packing
40 Lubricating space
41 Rolling bellows
42 Folding bellows
43 Fail-safe device
44 Locking washer
45 End teeth
46 Housing
47 Electromechanical lifting magnet
48 Locking pin
49 Wedge-shaped tip
50 Pivot bearing
51 Wheel carrier
52 Pivot bearing part
53 Pivoting pivot bearing part
54 Electromechanical actuator
55 Electric motor
56 Threaded spindle
57 Roller body
58 Track
59 Track

1. Device for modifying the wheel camber of a wheel (1) on a motor vehicle, comprising: the wheel (1) is mounted on a wheel carrier (5, 51) so that it can pivot via a pivot bearing (4, 50), wherein a pivot plane described by the pivot bearing (4, 50) is arranged at least approximately transverse to a center plane (E) of the wheel, wherein a position of a virtual rotational point (D) of the pivot bearing (4, 50) is above a wheel contact plane and on a side of the center plane (E) of the wheel facing the vehicle.

2. Device according to claim 1, wherein an intersection point (S) is formed by a Y-axis intersecting a rotational axis of the wheel (1) and lying in the center plane (E) of the wheel, with an X-axis lying in the wheel contact plane, wherein the rotational point (D) of the pivot bearing (4) relative to the intersection point (S) is arranged in a field, which is defined with X approximately equal to 150 mm and Y approximately equal to 150 mm.

3. Device according to claim 2, wherein the rotational point (D) of the pivot bearing (4) lies on a radius vector, which intersects the intersection point (S) and which covers an angular range of approximately 30° as a lower value up to approximately 60° as an upper value relative to the X-axis.

4. Device according to claim 1, wherein the pivot bearing (4, 50) has a fixed pivot bearing part (7, 52), which is fixed relative to the wheel carrier (5, 51), and a pivoting pivot bearing part (8, 53), which can pivot in the pivot plane relative to the fixed pivot bearing part (7, 52).

5. Device according to claim 4, wherein the wheel is mounted on the pivoting pivot bearing part (8, 53) so that it can rotate.

6. Device according to claim 4, wherein an electromechanical actuator (23, 54) is supported on one side relative to the wheel carrier (5, 51) and on another side engages the pivoting pivot bearing part (8, 53).

7. Device for modifying the wheel camber of a wheel (1) on a motor vehicle, comprising: the wheel (1) is mounted on a wheel carrier (5, 51) so that it can pivot via a pivot bearing (4, 50), wherein a pivot plane described by the pivot bearing (5, 51) is arranged at least approximately transverse to a center plane E of the wheel, the pivot bearing (4, 50) has a fixed pivot bearing part (7, 52), which is fixed relative to the wheel carrier (5, 51), and a pivoting pivot bearing part (8, 53), which can pivot in the pivot plane relative to the fixed pivot bearing part (7, 52), and the wheel (1) is mounted on the pivoting pivot bearing part (8, 53) so that it can rotate, an electromechanical actuator (23, 54) is supported on one side relative to the wheel carrier (5, 51) and on an other side engages the pivoting pivot bearing part (8, 53) for pivoting the pivot bearing part (8, 53).

8. Device according to claim 7, wherein the electromechanical actuator (23, 54) has an electric motor (24, 55) and a roller body screw drive, with a spindle nut (26) supported on a threaded spindle (27, 56) so that the spindle nut can rotate.

9. Device according to claim 8, wherein the spindle nut (26) comprises a rotor (25) of the electric motor (24), and the threaded spindle (27) is held locked against rotation.

10. Device according to claim 8, wherein the electric motor (24) is mounted on the wheel carrier (5).

11. Device according to claim 10, wherein the electric motor (24) is in direct metallic contact with the metallic wheel carrier (5).

12. Device according to claim 8, wherein the threaded spindle (27) is locked in rotation to the pivoting pivot bearing part (8) and is held so that it cannot move in an axial direction, and rocking movements of the pivoting pivot bearing part (8) relative to the threaded spindle (27) are performed about a rocking axis arranged transverse to the threaded spindle (27).

13. Device according to claim 12, wherein a peg (31) arranged transverse to the threaded spindle (27) is roller-supported in a radial direction on the threaded spindle (27) by a biased roller bearing (33), and the peg (31) is mounted on the pivoting pivot bearing part (8).

14. Device according to claim 7, wherein the wheel (1) is driven by a drive shaft (35), and the drive shaft (35) extends through the pivot bearing (4).

15. Device according to claim 14, wherein the drive shaft (35) extends through the wheel bearing (3).

16. Device according to claim 15, wherein the wheel bearing (3) is mounted on the pivoting pivot bearing part (8).

17. Device according to claim 14, wherein the drive shaft (35) is provided with a joint (36).

18. Device according to claim 15, wherein the pivot bearing (4), the wheel bearing (3), and the drive shaft (35) with the joint (36) are arranged one inside the other in a radial direction.

19. Device according to claim 18, wherein the pivot bearing (4), the wheel bearing (3), and the joint (36) of the drive shaft (35) are arranged in a common lubricating space (40) provided with lubricant.

20. Device according to claim 19, wherein the lubricating space (40) is defined by a folding or rolling bellows (37), which contacts, on one side, the fixed pivot bearing part (7) and, on the other side, the drive shaft (35).

21. Device according to claim 20, wherein a seal packing (38) mounted on the drive shaft (35) so that it can rotate is arranged between the seal and the drive shaft (35).

22. Device according to claim 7, wherein between the fixed pivot bearing part (7) and the pivoting pivot bearing part (8) there is a roller bearing having roller bodies (14) that roll on arc-shaped tracks (13, 16).

23. Device according to claim 22, wherein at least one endless roller body channel (17) is provided for the roller bearing in which the roller bodies (14) can circulate endlessly, and the roller body channel (14) has a load section (18) with the arc-shaped tracks (13, 16), a return section (19), and two deflection sections (20) connecting the load section (18) to the return section (19) to form an endless circuit.

24. Device according to claim 23, wherein the pivoting pivot bearing part (8) and the fixed pivot bearing part (7) are arranged one inside the other and are provided with the arc-shaped tracks (13, 16) on facing surfaces thereof.

25. Device according to claim 23, wherein one of the two pivot bearing parts (7, 8) is provided with the return sections (19).

26. Device according to claim 23, wherein head pieces (21) provided with the deflection sections (20) are arranged on opposing ends of the pivot bearing (4).

27. Device according to claim 24, wherein the outer fixed or pivoting pivot bearing part (7) is assembled from two longitudinal parts (10, 11), and the longitudinal axis of the pivot bearing part (7) lies in a dividing plane thereof.

28. Method for producing a device according to claim 27, wherein the outer fixed or pivoting pivot bearing part (8) is provided with desired fracture positions along the dividing plane, wherein an initially one-piece pivot bearing part (8) is broken apart along the desired fracture positions, so that the two longitudinal parts (10, 11) are formed, wherein the two longitudinal parts (10, 11) are provided with fracture surfaces, which enable a precisely fitting joining of the two longitudinal parts (10, 11), at their facing fracture positions lying in the dividing plane.

29. Device according to claim 24, wherein the inner pivoting or fixed pivot bearing part (7) has a tubular configuration viewed in cross section and is provided on an outer surface with several ridges (12) distributed over a periphery thereof and arranged concentric to the rotational point D of the pivot bearing (4), and the ridges (12) carry the tracks (13, 16).

30. Device according to claim 29, wherein the tracks (13, 16) are provided on opposite peripheral sides of the ridge (12).

31. Device according to claim 8, wherein a fail-safe device (43) is provided, with which a camber position of the wheel (1) can be detachably locked.

32. Device according to claim 31, wherein the fail-safe device (43) has a positive-fit part for positive-fit connection of the spindle nut (26) to a part fixed to a frame of the vehicle.
